(19) United States
(12) Patent Application Publication
(10) Pub. No.: US 2025/0234083 A1
(43) Pub. Date: Jul. 17, 2025

(54) INFORMATION PROCESSING APPARATUS AND CONTROL METHOD

(71) Applicant: Lenovo (Singapore) Pte. Ltd., Singapore (SG)

(72) Inventor: Kazuhiro Kosugi, Kanagawa (JP)

(73) Assignee: Lenovo (Singapore) Pte. Ltd., Singapore (SG)

(21) Appl. No.: 18/981,935

(22) Filed: Dec. 16, 2024

(30) Foreign Application Priority Data
Jan. 17, 2024 (JP) 2024-005347

(51) Int. Cl. H04N 23/611; G06F 3/01; G06V 40/16; H04N 23/90

(52) U.S. Cl. CPC H04N 23/611; G06F 3/013; G06V 40/161; H04N 23/90

(57) ABSTRACT

An information processing apparatus includes an internal camera, a connection unit configured to connect to one or a plurality of external cameras, a memory configured to temporarily store image data of an image captured by the internal camera or the external camera, a processor configured to perform processing using the image of the image data stored in the memory by executing an application program, and a detection unit configured to detect a direction of attention of an imaged person based on the image captured by the internal camera, in which the processor is configured to perform camera selection processing of selecting a camera for capturing an image to be used for the processing from the internal camera and the external camera, based on a positional relationship between the internal camera and the external camera and on the direction of attention of the person detected by the detection unit.

### CROSS-REFERENCE TO RELATED APPLICATIONS

This application claims priority to Japanese Patent Application No. 2024-005347 filed on Jan. 17, 2024, the contents of which are hereby incorporated herein by reference in their entirety.

### BACKGROUND OF THE INVENTION

### Field of the Invention

The present invention relates to an information processing apparatus and a control method.

### Description of the Related Art

In accordance with recent trends in work-from-anywhere (WFA), web conferences (video conferences) have been held using a personal computer (PC) equipped with a camera in various places and environments (for example, refer to Japanese Unexamined Patent Application Publication No. 2020-109954). There is also increasing use of multi-monitor by connecting external displays, and opportunities for the web conferences are also increasing.

Some external displays are equipped with cameras. In addition, widespread use of external cameras has allowed external displays not equipped with cameras to be used with external cameras. Thus, there are many users who participate in the web conferences in a state where not only an internal camera of a PC but also an external camera are installed.

### SUMMARY OF THE INVENTION

However, as described above, in participating in the web conference in a state where not only the internal camera of the PC but also the external camera are installed, attending the conference by seeing a display of a camera not set as a camera to be used for the web conference results in a video of a side view of a face as a participant of the conference and thus, is not preferable when another participant sees the video. While the cameras are manually switchable, a switching operation requires time and effort. A display to which attention is paid during the conference may change frequently, and the operation of switching the cameras each time is complicated and not practical.

The present invention has been conceived in view of the above circumstances, and one of the objects of the present invention is to provide an information processing apparatus and a control method capable of automatically switching to an appropriate camera among a plurality of cameras.

The present invention has been conceived in order to solve the problem. According to a first aspect of the present invention, there is provided an information processing apparatus including an internal camera, a connection unit configured to connect to one or a plurality of external cameras, a memory that temporarily stores image data of an image captured by the internal camera or the external camera, a processor that performs processing using the image of the image data stored in the memory by executing an application program, and a detection unit that detects a direction of attention of an imaged person based on the image captured by the internal camera, in which the processor is configured to perform camera selection processing of selecting a camera for capturing an image to be used for the processing from the internal camera and the external camera, based on a positional relationship between the internal camera and the external camera and on the direction of attention of the person detected by the detection unit.

In the information processing apparatus, the detection unit may be configured to detect a direction of a face of the person as the direction of attention of the person, and the processor may be configured to, in the camera selection processing, select the camera for capturing the image to be used for the processing from the internal camera and the external camera, based on the positional relationship between the internal camera and the external camera and on the direction of the face of the person detected by the detection unit.

In the information processing apparatus, the detection unit may be configured to detect a direction of a sight-line of the person as the direction of attention of the person, and the processor may be configured to, in the camera selection processing, select the camera for capturing the image to be used for the processing from the internal camera and the external camera, based on the positional relationship between the internal camera and the external camera and on the direction of the sight-line of the person detected by the detection unit.

In the information processing apparatus, the detection unit may be configured to detect a direction of a face of the person and a direction of a sight-line of the person as the direction of attention of the person, and the processor may be configured to, in the camera selection processing, select the camera for capturing the image to be used for the processing from the internal camera and the external camera, based on the positional relationship between the internal camera and the external camera and on the direction of the face of the person and the direction of the sight-line of the person detected by the detection unit.

In the information processing apparatus, the processor may be configured to, in the camera selection processing, select a camera at a position closer to the direction of attention of the person out of the internal camera and the external camera.

In the information processing apparatus, the processor may include, as an option enabling a user to select the camera for capturing the image to be used for the processing, a virtual camera that is switched between the internal camera and the external camera by selecting any of the internal camera or the external camera through the camera selection processing, in addition to the internal camera and the external camera, and may be configured to, in a case where the user selects the virtual camera, execute the camera selection processing.

According to a second aspect of the present invention, there is provided an information processing apparatus including an internal camera, a connection unit configured to connect to one or a plurality of external cameras, a memory configured to temporarily store image data of an image captured by the internal camera or the external camera, a processor configured to perform processing using the image of the image data stored in the memory by executing an application program, and a detection unit configured to detect a direction of attention of an imaged person based the image captured by the internal camera, in which the processor is configured to display a first option for selecting the internal camera, a second option for selecting the external camera, and a third option for selecting any of the internal camera or the external camera, on a display unit as an option enabling a user to select a camera for capturing an image to be used for the processing, and in a case where the user selects the third option, perform camera selection processing of selecting the camera for capturing the image to be used for the processing from the internal camera and the external camera, based on a positional relationship between the internal camera and the external camera and on the direction of attention of the person detected by the detection unit.

In the information processing apparatus, the detection unit may be configured to further detect the direction of attention of the imaged person based on the image captured by the external camera, and the processor may be configured to detect the positional relationship between the internal camera and the external camera based on the direction of attention of the person detected by the detection unit based on the image captured by the internal camera and on the direction of attention of the person detected based on the image captured by the external camera.

In the information processing apparatus, the processor may be configured to detect the positional relationship between the internal camera and the external camera in response to connection of the external camera.

In the information processing apparatus, the processor may be configured to detect the positional relationship between the internal camera and the external camera at predetermined time intervals after the external camera is connected.

In the information processing apparatus, the external camera may be incorporated in an external display device including an external display unit connected to the information processing apparatus, and the processor may be configured to detect the positional relationship between the internal camera and the external camera based on setting information of a position of the external display unit with respect to a position of an internal display unit included in the information processing apparatus.

In the information processing apparatus, the processor may be configured to display a setting screen enabling a user to set a position of the external camera with respect to a position of the internal camera, on a display unit, and detect the positional relationship between the internal camera and the external camera based on the position of the external camera with respect to the position of the internal camera, set by an operation of the user on the setting screen.

According to a third aspect of the present invention, there is provided a control method in an information processing apparatus including an internal camera, a connection unit configured to connect to one or a plurality of external cameras, a memory configured to temporarily store image data of an image captured by the internal camera or the external camera, a processor configured to perform processing using the image of the image data stored in the memory by executing an application program, and a detection unit configured to detect a direction of attention of an imaged person based on the image captured by the internal camera, the control method including a step of acquiring, via the processor, the direction of attention of the person detected by the detection unit, and a step of selecting, via the processor, a camera for capturing an image to be used for the processing from the internal camera and the external camera, based on a positional relationship between the internal camera and the external camera and on the direction of attention of the person detected by the detection unit.

According to a fourth aspect of the present invention, there is provided a control method in an information processing apparatus including an internal camera, a connection unit configured to connect to one or a plurality of external cameras, a memory configured to temporarily store image data of an image captured by the internal camera or the external camera, a processor configured to perform processing using the image of the image data stored in the memory by executing an application program, and a detection unit configured to detect a direction of attention of an imaged person based on the image captured by the internal camera, the control method including a step of displaying, via the processor, a first option for selecting the internal camera, a second option for selecting the external camera, and a third option for selecting any of the internal camera or the external camera, on a display unit as an option enabling a user to select a camera for capturing an image to be used for the processing, and a step of selecting, via the processor, in a case where the user selects the third option, the camera for capturing the image to be used for the processing from the internal camera and the external camera, based on a positional relationship between the internal camera and the external camera and on the direction of attention of the person detected by the detection unit.

According to the aspects of the present invention, automatic switching to an appropriate camera among a plurality of cameras is enabled.

### BRIEF DESCRIPTION OF THE DRAWINGS

FIG. 1 is a perspective view illustrating a configuration example of an exterior of an information processing apparatus according to one or more embodiments.

FIG. 2 is a diagram illustrating an example of a person detection range of a laptop PC according to one or more embodiments.

FIG. 3 is a diagram illustrating an example of a use environment of the laptop PC according to one or more embodiments.

FIGS. 4(A) and 4(B) are descriptive diagrams of a camera switching control via the laptop PC according to one or more embodiments.

FIG. 5 is a schematic block diagram illustrating an example of a hardware configuration of the laptop PC according to one or more embodiments.

FIG. 6 is a schematic block diagram illustrating an example of a configuration related to the camera switching control according to one or more embodiments.

FIG. 7 is a diagram illustrating an example of a camera selection screen according to one or more embodiments.

FIG. 8 is a flowchart illustrating an example of camera switching control processing according to one or more embodiments.

FIG. 9 is a diagram illustrating an example of a camera position setting screen according to one or more embodiments.

### DETAILED DESCRIPTION OF THE INVENTION

Hereinafter, embodiments of the present invention will be described with reference to the drawings.

### Overview

First, an overview of embodiments of the present invention will be described.

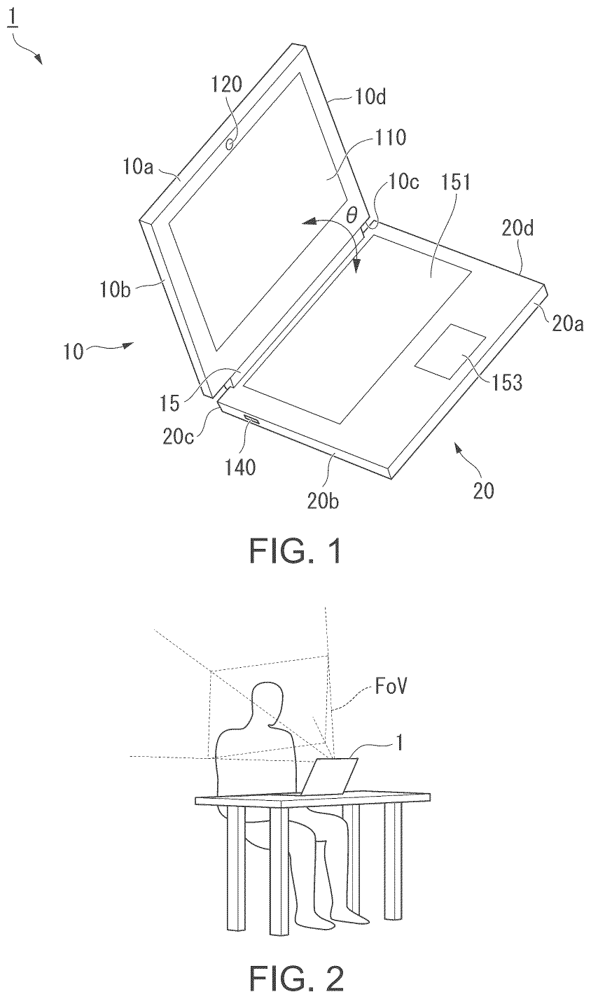

FIG. 1 is a perspective view illustrating a configuration example of an exterior of an information processing apparatus according to one or more embodiments. A laptop PC 1 as a personal computer (PC) of a laptop type (a clamshell type) will be described as an example of the information processing apparatus according to one or more embodiments.

The laptop PC 1 includes a first chassis 10, a second chassis 20, and a hinge mechanism 15. The first chassis 10 and the second chassis 20 are joined to each other using the hinge mechanism 15. The first chassis 10 is pivotable relative to the second chassis 20 about an axis of rotation of the hinge mechanism 15. An opening angle formed by pivoting the first chassis 10 and the second chassis 20 is illustrated as “θ”.

The first chassis 10 is also referred to as an A cover or a display chassis. The second chassis 20 is also referred to as a C cover or a system chassis. In the following description, surfaces included in the hinge mechanism 15 among side surfaces of the first chassis 10 and the second chassis 20 will be referred to as side surfaces 10c and 20c, respectively. Surfaces opposite to the side surfaces 10c and 20c among the side surfaces of the first chassis 10 and the second chassis 20 will be referred to as side surfaces 10a and 20a, respectively. In the drawing, a direction of the side surface 20c from the side surface 20a will be referred to as “rear”, and a direction of the side surface 20a from the side surface 20c will be referred to as “front”. A rightward direction and a leftward direction with respect to a rearward direction will be referred to as “right” and “left”, respectively. In the first chassis 10 and the second chassis 20, left side surfaces will be referred to as side surfaces 10b and 20b, respectively, and right side surfaces will be referred to as side surfaces 10d and 20d, respectively. A state where the first chassis 10 and the second chassis 20 are overlaid with each other to be completely closed (a state of opening angle θ=0°) will be referred to as a “closed state”. In the first chassis 10 and the second chassis 20, surfaces facing each other in the closed state will be referred to as “inner surfaces”, and surfaces opposite to the inner surfaces will be referred to as “outer surfaces”. A state where the first chassis 10 and the second chassis 20 are open with respect to the closed state will be referred to as an “open state”.

An exterior of the laptop PC 1 illustrated in FIG. 1 illustrates an example of the open state. The open state is a state where the side surface 10a of the first chassis 10 and the side surface 20a of the second chassis 20 are away from each other. In the open state, the inner surfaces of the first chassis 10 and the second chassis 20 are revealed. The open state is one of states where a user uses the laptop PC 1. The laptop PC 1 is typically used in a state of opening angle θ=approximately 100° to 130°. A range of the opening angle θ resulting in the open state is determinable to be any range in accordance with a pivotable angular range of the hinge mechanism 15 or the like.

A display unit 110 is provided on the inner surface of the first chassis 10. The display unit 110 includes a liquid crystal display (LCD), an organic electroluminescence (EL) display, or the like. An internal camera 120 as an imaging unit is provided in a region of a peripheral edge of the display unit 110 on the inner surface of the first chassis 10. For example, the internal camera 120 is disposed closer to the side surface 10a in the region of the peripheral edge of the display unit 110. A position at which the internal camera 120 is disposed is merely an example, and the internal camera 120 may be disposed at any other places at which the internal camera 120 is directable in a direction facing a display screen of the display unit 110.

The internal camera 120 images a predetermined imaging range in the direction facing the display screen of the display unit 110 (that is, a forward direction of the laptop PC 1) in the open state. The predetermined imaging range is a range of an angle of view determined by an imaging element included in the internal camera 120 and by an optical lens provided in a forward direction of an imaging surface of the imaging element. For example, the internal camera 120 is capable of capturing an image including a person (the user) present in the forward direction (closer to a front surface) of the laptop PC 1.

A power button 140 is provided on the side surface 20b of the second chassis 20. The power button 140 is an operator that allows the user to provide an instruction for powering on or off, a transition from a waiting state to a normal operating state, a transition from the normal operating state to the waiting state, and the like. The normal operating state is an operating state of a system where processing is executable without particular restrictions, and corresponds to, for example, the state S0 defined in Advanced Configuration and Power Interface (ACPI).

The waiting state is a state where at least a part of system processing is restricted. For example, the waiting state is a state where the system is locked. In a state where the system is locked, an image (for example, an image for locking) set in advance is displayed on the display unit so that content being processed is not visible. Unlocking requires login authentication of the user. The waiting state may be a standby state, a sleep state, or the like or may be a state corresponding to Modern Standby in Windows (registered trademark), the state S3 (a sleep state) defined in ACPI, or the like. For example, the waiting state is a state having lower power consumption than the normal operating state.

A keyboard 151 and a touchpad 153 are provided on the inner surface of the second chassis 20 as an input device for receiving an operation input of the user. As the input device, a mouse or an external keyboard may be connected, or a touch panel for receiving an operation on the display screen of the display unit 110 may be provided, instead of or in addition to the keyboard 151 and the touchpad 153.

The laptop PC 1 detects a person present in the forward direction of the laptop PC 1 based on the captured image captured by the internal camera 120.

FIG. 2 is a diagram illustrating an example of a person detection range of the laptop PC 1 according to one or more embodiments. In the illustrated example, a detection range field of view (FoV) in the forward direction of the laptop PC 1 is a range in which a person is detectable. That is, the laptop PC 1 detects the user who is present in the forward direction of the laptop PC 1 and who is using the laptop PC 1. The detection range FoV corresponds to an imaging angle of view imaged by the laptop PC 1. For example, the laptop PC 1 detects a face region in which a face of the user is imaged, a direction of the face (a face angle) from the captured image captured by the internal camera 120.

Next, an example of using the laptop PC 1 in a web conference or the like by connecting an external display and an external camera to the laptop PC 1 will be described.

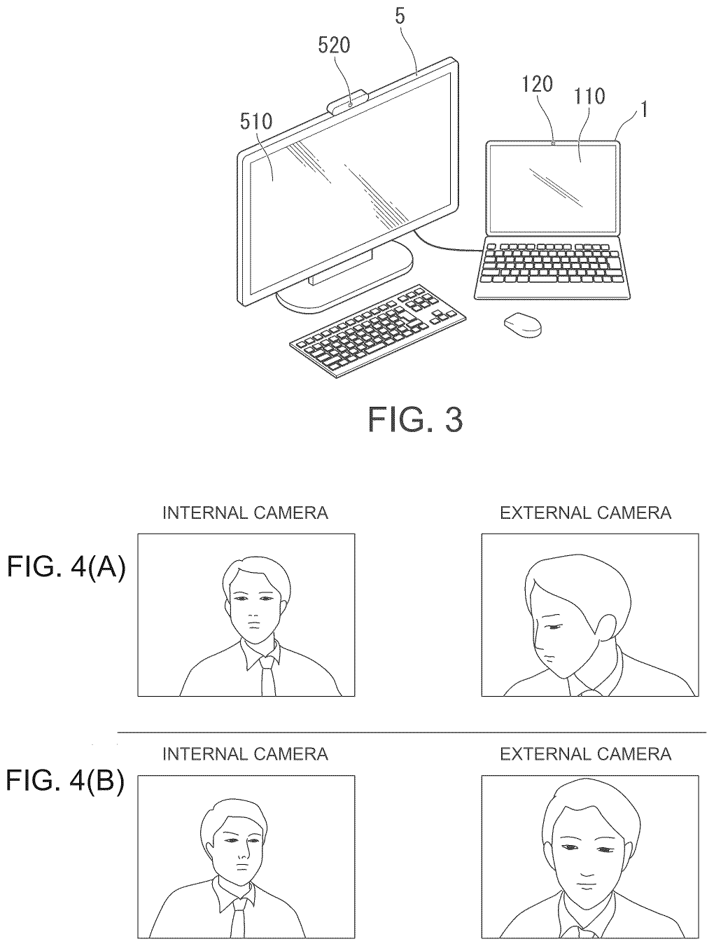

FIG. 3 is a diagram illustrating an example of a use environment of the laptop PC 1 according to one or more embodiments. The laptop PC 1 is connected to an external display device 5 (a display device). The external display device 5 includes a display unit 510 as an external display. For example, the laptop PC 1 and the external display device 5 are connected to each other using an HDMI (registered trademark) cable, a USB (Type-C) cable, or a display port cable. The laptop PC 1 may be wirelessly connected to the external display device 5.

The external display device 5 is provided with an external camera 520 as an external imaging unit. For example, the external camera 520 is attached to an upper end of the external display device 5 and images a predetermined imaging range in a direction facing a display screen of the display unit 510 (the external display) (that is, in a forward direction of the external display). The predetermined imaging range is a range of an angle of view determined by an imaging element included in the external camera 520 and by an optical lens provided in a forward direction of an imaging surface of the imaging element. That is, the external camera 520 images the user present in the forward direction of the laptop PC 1 in a different direction from the internal camera 120 (a direction of the external display device 5). The external camera 520 is connected to the laptop PC 1 through a USB cable or the like and outputs image data of a captured image to the laptop PC 1. The external camera 520 may be incorporated in the external display device 5.

In the example of the use environment illustrated in FIG. 3, the external display device 5 and the external camera 520 are positioned on the left of the laptop PC 1 and the internal camera 120 when seen from the user. In such a use environment, the laptop PC 1 switches between the internal camera 120 and the external camera 520 in accordance with a positional relationship between the internal camera 120 and the external camera 520 and with a direction of attention of the user attending the web conference.

FIG. 4 is a descriptive diagram of a camera switching control via the laptop PC 1 according to one or more embodiments. FIG. 4(A) illustrates an example of the captured image of the internal camera 120 and the captured image of the external camera 520 when the user is paying attention in the direction of the laptop PC 1 in the use environment in FIG. 3. The face of the user in the captured image of the internal camera 120 is directed to the front, and the face of the user in the captured image of the external camera 520 is directed to a side. When the user is paying attention in the direction of the laptop PC 1, the face of the user in the captured image of the internal camera 120 is directed to the front. Thus, the laptop PC 1 uses the internal camera 120 in the web conference. For example, when the external camera 520 is used in the web conference, in a case where the direction of the face of the user in the captured image of the internal camera 120 is determined to be directed to the front, the laptop PC 1 switches to the internal camera 120 from the external camera 520.

FIG. 4(B) illustrates an example of the captured image of the internal camera 120 and the captured image of the external camera 520 when the user is paying attention in the direction of the external display device 5 in the use environment in FIG. 3. The face of the user in the captured image of the internal camera 120 is directed to a side, and the face of the user in the captured image of the external camera 520 is directed to the front. When the user is paying attention in the direction of the external display device 5, the face of the user in the captured image of the internal camera 120 is directed in a direction of the external camera 520 and is not directed to the front. Thus, the laptop PC 1 uses the external camera 520 in the web conference. For example, when the external camera 520 is used in the web conference, in a case where the direction of the face of the user in the captured image of the internal camera 120 is determined to be directed in the direction of the external camera 520 and not directed to the front, the laptop PC 1 switches to the external camera 520 from the internal camera 120.

As described above, the laptop PC 1 according to one or more embodiments selects a camera for capturing an image to be used for processing such as the web conference from the internal camera 120 and the external camera 520 based on the positional relationship between the internal camera 120 and the external camera 520 and on the direction of attention (for example, the direction of the face) of the user detected from the captured image captured by the internal camera 120. Hereinafter, a configuration of the laptop PC 1 according to one or more embodiments will be described in detail.

### [Hardware Configuration of Information Processing Apparatus]

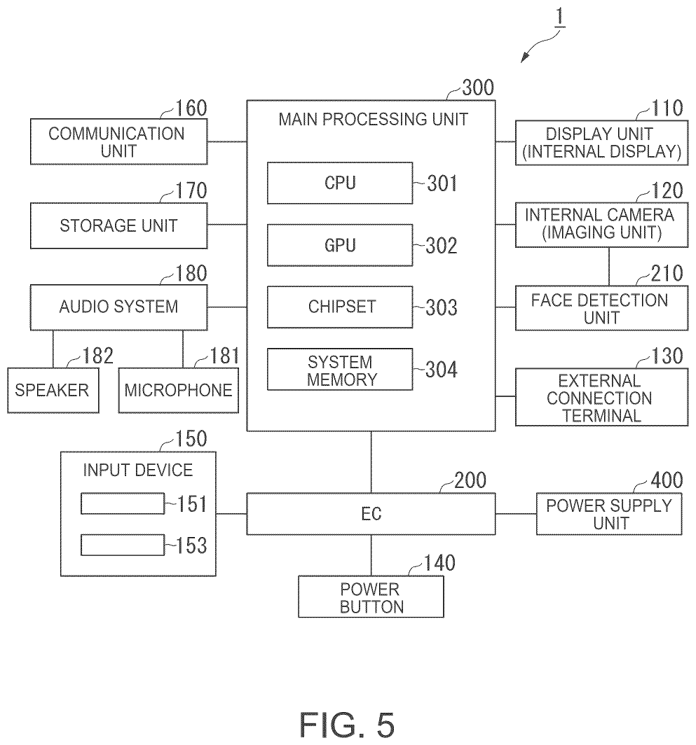

FIG. 5 is a schematic block diagram illustrating an example of a hardware configuration of the laptop PC 1 according to one or more embodiments. In FIG. 5, a configuration corresponding to each unit in FIG. 1 is designated by the same symbol. The laptop PC 1 includes the display unit 110, the internal camera 120, an external connection terminal 130, the power button 140, an input device 150, a communication unit 160, a storage unit 170, an audio system 180, a microphone 181, a speaker 182, an embedded controller (EC) 200, a face detection unit 210, a main processing unit 300, and a power supply unit 400.

As illustrated in FIG. 1, the display unit 110 is an internal display incorporated in the laptop PC 1. The display unit 110 displays display data (an image) generated based on system processing executed by the main processing unit 300, processing of an application program that operates in the system processing, and the like.

As illustrated in FIG. 1, the internal camera 120 is an imaging unit provided on the inner surface of the first chassis 10. The internal camera 120 captures an image of an object within the predetermined imaging range (the angle of view) in a direction (a forward direction) facing the inner surface of the first chassis 10 and outputs the captured image to the main processing unit 300 and the face detection unit 210. For example, the internal camera 120 includes a visible light camera (an RGB camera) that performs imaging using visible light, and an infrared camera (an IR camera) that performs imaging using an infrared ray.

The internal camera 120 may include any one of the visible light camera or the infrared camera or may include both of the visible light camera and the infrared camera.

The external connection terminal 130 is a connection terminal for connecting to the external display device 5 and the external camera 520. For example, the external connection terminal 130 includes an HDMI (registered trademark) terminal, a USB Type-C terminal, or a display port and is connected to the external display device 5 through a cable. The external connection terminal 130 includes a USB Type-A terminal, a USB Type-C terminal, or the like and is connected to the external camera 520 through a cable. The laptop PC 1 and the external display device 5, or the laptop PC 1 and the external camera 520 may be wirelessly connected through the communication unit 160.

The power button 140 outputs an operation signal to the EC 200 in accordance with an operation of the user. The input device 150 is an input unit that receives an input provided by the user, and includes, for example, the keyboard 151 and the touchpad 153. The input device 150 outputs an operation signal indicating operation content to the EC 200 in response to reception of the operation on the keyboard 151 and the touchpad 153.

The communication unit 160 is connected to be capable of communicating with other apparatuses through a wireless or wired communication network and transmits and receives various types of data. For example, the communication unit 160 includes a wired LAN interface such as Ethernet (registered trademark) or a wireless LAN interface such as Wi-Fi (registered trademark).

The storage unit 170 includes a storage medium such as a hard disk drive (HDD), a solid state drive (SSD), a random access memory (RAM), a read only memory (ROM), or the like. The storage unit 170 stores various programs such as an OS, a device driver, an application (for example, an application for the web conference), and the like and also stores various types of data acquired by operating the programs.

The audio system 180 is connected to the microphone 181 and the speaker 182 and records, reproduces, and outputs sound data. For example, the audio system 180 converts a voice signal of voice collected by the microphone 181 into digital voice data and transmits the voice data to the main processing unit 300. The audio system 180 converts voice data transmitted from the main processing unit 300 into an analog voice signal and outputs the voice signal from the speaker 182 as voice. For example, when the application of the web conference is executed, the microphone 181 and the speaker 182 are used for collecting voice of the user (a participant of the web conference) and outputting voice of other participants of the web conference.

The power supply unit 400 supplies power to each unit in accordance with an operating state of each unit of the laptop PC 1. The power supply unit 400 includes a direct current (DC)/DC converter. The DC/DC converter converts a voltage of direct current power supplied from an alternate current (AC)/DC adapter or a battery (a battery pack) into a voltage required by each unit. Power of which a voltage is converted by the DC/DC converter is supplied to each unit through each power supply system. For example, the power supply unit 400 supplies power to each unit through each power supply system based on a control signal input from the EC 200.

The EC 200 is a microcomputer including a central processing unit (CPU), a random access memory (RAM), a read only memory (ROM), an input/output (I/O) logic circuit, and the like. The CPU of the EC 200 reads a control program (firmware) stored in advance in the ROM and performs a function of the control program by executing the read control program. The EC 200 operates independently of the main processing unit 300, controls operating of the main processing unit 300, and manages an operating state of the main processing unit 300. The EC 200 is connected to the power button 140, the input device 150, the power supply unit 400, and the like.

For example, the EC 200 communicates with the power supply unit 400 to acquire information about a state (a remaining capacity or the like) of the battery from the power supply unit 400 and to output the control signal for controlling supply of power corresponding to the operating state of each unit of the laptop PC 1 to the power supply unit 400. The EC 200 acquires the operation signals from the power button 140 or the input device 150 and outputs the operation signal related to processing of the main processing unit 300 among the acquired operation signals to the main processing unit 300.

The face detection unit 210 includes a processor that processes image data of the captured image captured by the internal camera 120. The face detection unit 210 acquires the image data of the captured image captured by the internal camera 120 and temporarily stores the acquired image data in a memory. The memory for storing the image data may be a system memory 304 or a memory (not illustrated) in the face detection unit 210.

For example, the face detection unit 210 performs face detection processing such as detecting the face region (a region of a face image) and the direction of the face (the face angle) from the captured image, by processing the image data of the captured image acquired from the internal camera 120. In a case where the face region is detected from the captured image, the face detection unit 210 outputs face angle information indicating the face angle to the main processing unit 300.

The face angle will be described. For example, when the direction of the face of the user is directed in the direction of the laptop PC 1 (the internal camera 120) (that is, in a state where the user is facing the display unit 110 and the internal camera 120), a front face of the user is imaged from the internal camera 120. The face angle at this point (that is, the face angle when the face of the user is in front of the internal camera 120) is 0 degrees. For example, the face angle in a horizontal direction increases in a positive direction as the user turns to the right, and the face angle in the horizontal direction increases in a negative direction as the user turns to the left. The face angle in a vertical direction increases in a positive direction as the user looks up, and the face angle in the vertical direction increases in a negative direction as the user looks down. With such a definition, the face detection unit 210 detects the face angle of the user from the captured image of the internal camera 120.

The face detection unit 210 is also capable of performing the face detection processing such as detecting the face region and the direction of the face (the face angle) from the captured image, by processing the image data of the captured image captured by the external camera 520.

The main processing unit 300 includes a central processing unit (CPU) 301, a graphic processing unit (GPU) 302, a chipset 303, and the system memory 304 and is capable of executing processing of various application programs on an operating system (OS) by performing the system processing based on the OS.

The CPU 301 is a processor that executes processing based on a program of a BIOS, processing based on a program of the OS, processing based on an application program operating on the OS, and the like. For example, the CPU 301 executes processing of the application for the web conference. The CPU 301 performs the camera switching control of switching between the internal camera 120 and the external camera 520 in accordance with the positional relationship between the internal camera 120 and the external camera 520 and with the direction of attention of the user attending the web conference, based on a result or the like of the face detection processing via the face detection unit 210. The camera switching control will be described in detail later.

The GPU 302 is connected to the display unit 110 (the internal display). The GPU 302 generates display data by executing image processing under control of the CPU 301. The GPU 302 outputs the generated display data to the display unit 110 (the internal display). In a case where the external display device 5 is connected, the display data generated by the GPU 302 is also output to the external display device 5 (the external display) through, for example, the external connection terminal 130.

The chipset 303 has a function as a memory controller, a function as an I/O controller, and the like. For example, the chipset 303 controls reading and writing of data from the system memory 304, the storage unit 170, and the like via the CPU 301 and the GPU 302. The chipset 303 controls input and output of data from the display unit 110 (the internal display), the internal camera 120, the communication unit 160, the audio system 180, and the EC 200. The chipset 303 has a function as a sensor hub. For example, the chipset 303 acquires the face detection result (the face angle information or the like) acquired from the face detection unit 210 and outputs the face detection result to the CPU 301.

The system memory 304 is used as a reading region for a program executed by the CPU 301, a work region for writing processing data, and the like. The system memory 304 temporarily stores the image data of the captured image captured by the internal camera 120.

The CPU 301, the GPU 302, and the chipset 303 may be configured as one integrated processor, or a part or each of the CPU 301, the GPU 302, and the chipset 303 may be configured as an individual processor. For example, the normal operating state is a state where all of the CPU 301, the GPU 302, and the chipset 303 are operating, and the waiting state is a state where only at least a part of the chipset 303 is operating.

### [Functional Configuration Related to Camera Switching Control]

Next, a configuration of performing the camera switching control via the laptop PC 1 will be described in detail.

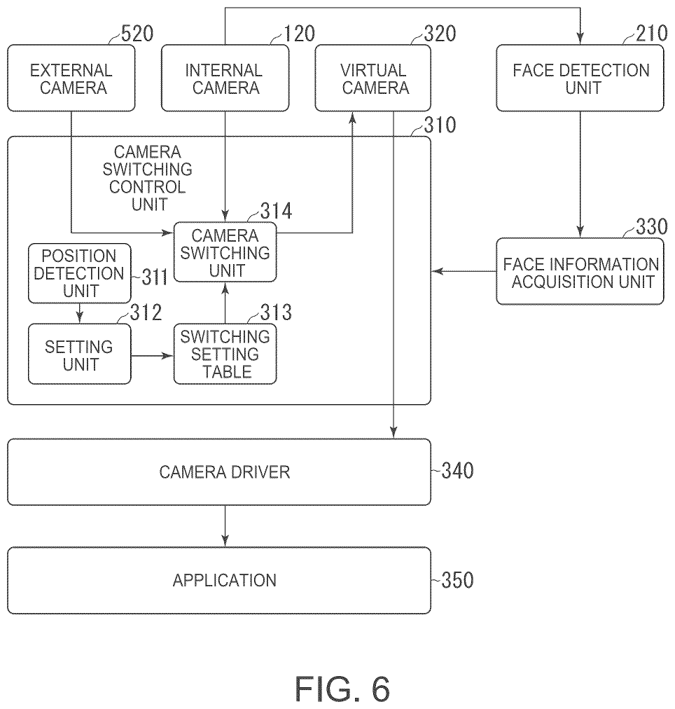

FIG. 6 is a schematic block diagram illustrating an example of a configuration related to the camera switching control according to one or more embodiments. In FIG. 6, a configuration corresponding to each unit in FIGS. 1 and 5 is designated by the same symbol. A camera switching control unit 310, a virtual camera 320, a face information acquisition unit 330, a camera driver 340, and an application 350 illustrated in this drawing are functional configurations implemented by executing each program via the main processing unit 300. The virtual camera 320 functions as a camera that is automatically switched between the internal camera 120 and the external camera 520 under control of the camera switching control unit 310.

For example, the application 350 is the application for the web conference. The application 350 is capable of selecting the camera for imaging the user (the participant) in the web conference from the internal camera 120, the external camera 520, and the virtual camera 320.

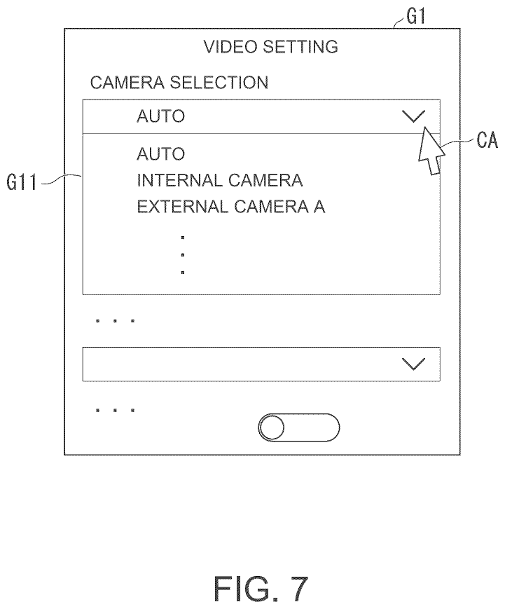

FIG. 7 is a diagram illustrating an example of a camera selection screen according to one or more embodiments. A video setting screen G1 illustrated is an example of a user interface (UI) for making various settings of a video to be displayed in the application 350. The camera for capturing the image to be used for processing of the application 350 is selectable in a camera selection field indicated by symbol 11 in the video setting screen G1. In this camera selection field, options of the camera selectable by the user including AUTO, INTERNAL CAMERA, EXTERNAL CAMERA A, . . . are displayed. The user selects a desired camera by performing an operation of moving a cursor CA to an option and determining (clicking) the option using the touchpad 153, the mouse, or the like.

AUTO corresponds to the virtual camera 320, and in a case where this option is selected, the camera for capturing the image to be used for the processing of the application 350 is automatically switched to any of the internal camera 120 or the external camera 520.

INTERNAL CAMERA corresponds to the internal camera 120, and in a case where this option is selected, the camera for capturing the image to be used for the processing of the application 350 is fixed as the internal camera 120. The image data of the captured image captured by the internal camera 120 is usable by the application 350 through the camera driver 340.

EXTERNAL CAMERA A corresponds to the external camera 520, and in a case where this option is selected, the camera for capturing the image to be used for the processing of the application 350 is fixed as the external camera 520. The image data of the captured image captured by the external camera 520 is usable in the application 350 through the camera driver 340.

In a case where a plurality of external cameras 520 are connected to the laptop PC 1, options of not only EXTERNAL CAMERA A but also the plurality of external cameras are displayed. While AUTO, INTERNAL CAMERA, and EXTERNAL CAMERA A are illustrated as options in the drawing, this illustration is merely for convenience, and any illustration for identifying the cameras is usable in actuality.

A control when AUTO (the virtual camera 320) is selected by the user will be described with reference to FIG. 6 again. The camera switching control unit 310 performs camera selection processing of selecting the camera for capturing the image to be used for the processing of the application 350 from the internal camera 120 and the external camera 520, based on the positional relationship between the internal camera 120 and the external camera 520 and on the direction of attention of the user.

For example, the camera switching control unit 310 acquires the face angle information indicating the direction of the face (the face angle) of the user detected by the face detection unit 210, as information indicating the direction of attention of the user through the face information acquisition unit 330. The face angle information of the user acquired by the camera switching control unit 310 is the face angle information of a main user. In a case where the face detection unit 210 detects the face regions of a plurality of users, a user having the face region closest to a center, a user having the largest face region, or the like is determined as the main user.

In the camera selection processing, the camera switching control unit 310 selects a source of the image data to be input into the virtual camera 320 from the image data of the captured image captured by the internal camera 120 and the image data of the captured image captured by the external camera 520, based on the positional relationship between the internal camera 120 and the external camera 520 and on the direction of the face (the face angle) of the user detected by the face detection unit 210.

For example, the camera switching control unit 310 includes a position detection unit 311, a setting unit 312, a switching setting table 313, and a camera switching unit 314. In a case where the external camera 520 is connected to the laptop PC 1, the position detection unit 311 initializes the positional relationship between the internal camera 120 and the external camera 520. For example, in a case where the main processing unit 300 detects connection of the external camera 520 through the external connection terminal 130, the position detection unit 311 detects the positional relationship between the internal camera 120 and the external camera 520 in response to the connection of the external camera 520 to the laptop PC 1. The position detection unit 311 may detect the positional relationship between the internal camera 120 and the external camera 520 at predetermined time intervals after the external camera 520 is connected to the laptop PC 1.

For example, the positional relationship between the internal camera 120 and the external camera 520 is a position of the external camera 520 with respect to the internal camera 120 and includes whether the external camera 520 is on the left or the right of the internal camera 120. Alternatively, the positional relationship between the internal camera 120 and the external camera 520 may include whether the external camera 520 is above or below the internal camera 120.

For example, the position detection unit 311 detects the positional relationship between the internal camera 120 and the external camera 520 based on a difference between the face angles of the user detected from the captured images of each of the internal camera 120 and the external camera 520 by the face detection unit 210. In this case, the positional relationship between the internal camera 120 and the external camera 520 may include not only the left and right or up and down relationship but also information about a difference between positions (the difference between the face angles from each camera).

The setting unit 312 sets threshold values of the face angle for switching between the internal camera 120 and the external camera 520, in the switching setting table 313 based on the positional relationship between the internal camera 120 and the external camera 520 detected by the position detection unit 311 and on the face angle of the user.

The switching setting table 313 is set by the setting unit 312 such that a camera at a position closer to the direction of the face (the direction of attention) of the user out of the internal camera 120 and the external camera 520 is selected. Specifically, a threshold value of the face angle corresponding to the internal camera 120 and a threshold value of the face angle corresponding to the external camera 520 are set in the switching setting table 313. For example, in the switching setting table 313, a range of the face angle for selecting the internal camera 120 (a range in which the user is determined as paying attention in a direction of the internal camera 120) and a range of the face angle for selecting the external camera 520 (a range in which the user is determined as paying attention in the direction of the external camera 520) may be set as the threshold values. Alternatively, the face angle for switching from the internal camera 120 to the external camera 520 and the face angle for switching from the external camera 520 to the internal camera 120 may be set as the threshold values.

The camera switching unit 314 switches between inputting the image data of the captured image captured by the internal camera 120 into the virtual camera 320 or inputting the image data of the captured image captured by the external camera 520 into the virtual camera 320. For example, the camera switching unit 314 acquires the current face angle information of the user detected from the captured image captured by the internal camera 120 through the face information acquisition unit 330. Specifically, the camera switching unit 314 inputs the image data from the camera at the position closer to the direction of the face (the direction of attention) of the user out of the internal camera 120 and the external camera 520, into the virtual camera 320 based on the acquired face angle information and on the switching setting table 313.

In a case where the camera switching unit 314 selects the internal camera 120, the image data of the captured image captured by the internal camera 120 is usable in the application 350 through the camera driver 340. That is, the captured image captured by the internal camera 120 is displayed in the application for the web conference.

Meanwhile, in a case where the camera switching unit 314 selects the external camera 520, the image data of the captured image captured by the external camera 520 is usable in the application 350 through the camera driver 340. That is, the captured image captured by the external camera 520 is displayed in the application for the web conference.

### [Operating of Camera Switching Control Processing]

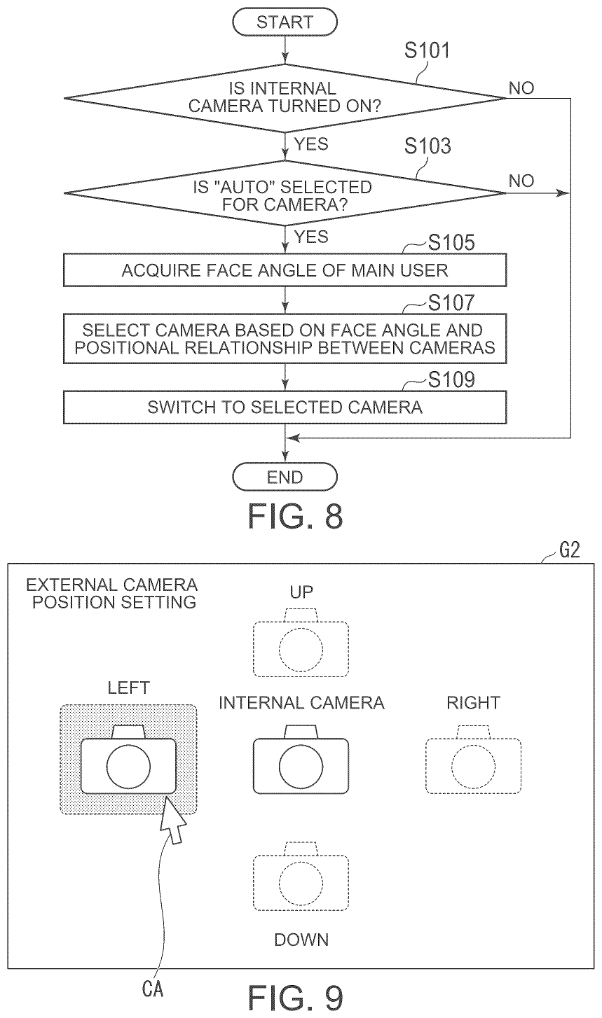

Next, operating of camera switching control processing of switching between the internal camera 120 and the external camera 520 in accordance with the direction of the face (the face angle) of the user via the laptop PC 1 will be described with reference to FIG. 8.

FIG. 8 is a flowchart illustrating an example of the camera switching control processing according to one or more embodiments.

(Step S101) The laptop PC 1 determines whether or not the internal camera 120 is turned on. In a case where the internal camera 120 is turned off (NO), the laptop PC 1 does not need to perform the camera switching control processing and thus, finishes the processing. Meanwhile, in a case where the internal camera 120 is turned on (YES), the laptop PC 1 proceeds to the processing in step S103.

(Step S103) The laptop PC 1 determines whether or not selection of the camera is AUTO (refer to FIG. 7) in the application 350. In a case where selection of the camera other than AUTO (for example, INTERNAL CAMERA or EXTERNAL CAMERA) is made (NO), the laptop PC 1 does not need to perform the camera switching control processing and thus, finishes the processing. Meanwhile, in a case where selection of the camera is AUTO (YES), the laptop PC 1 proceeds to the processing in step S105.

(Step S105) The laptop PC 1 acquires the current face angle of the user (the main user) detected from the captured image captured by the internal camera 120. For example, the laptop PC 1 acquires the current face angle information of the user (the main user) detected through processing of the face detection unit 210 from the captured image captured by the internal camera 120. The processing proceeds to step S107.

(Step S107) The laptop PC 1 selects the internal camera 120 or the external camera 520 based on the face angle information acquired in step S105 and on the switching setting table 313. That is, the laptop PC 1 selects the internal camera 120 or the external camera 520 based on the current face angle of the user and on the positional relationship between the internal camera 120 and the external camera 520. The processing proceeds to step S109.

(Step S109) The laptop PC 1 switches the camera for capturing the image to be input into the virtual camera 320 to the camera selected in step S107 out of the internal camera 120 and the external camera 520. In a case where the camera selected in step S107 is the camera that is currently selected, the laptop PC 1 maintains the selected camera.

### Summary of Embodiments

As described above, the laptop PC 1 (an example of the information processing apparatus) according to one or more embodiments includes the internal camera 120, the external connection terminal 130 (an example of a connection unit) for connecting to the external camera 520, the system memory 304 (an example of a memory), the main processing unit 300 (an example of a processor), and the face detection unit 210 (an example of a detection unit). For example, the system memory 304 temporarily stores the image data of the image captured by the internal camera 120 or the external camera 520. The main processing unit 300 performs processing using the image of the image data stored in the system memory 304 by executing the application 350 (an example of an application program). The face detection unit 210 detects the direction of attention of the imaged user (an example of a person) based on the image captured by the internal camera 120. The main processing unit 300 performs the camera switching control processing (an example of camera selection processing) of selecting the camera for capturing the image to be used for the processing of the application 350 from the internal camera 120 and the external camera 520, based on the positional relationship between the internal camera 120 and the external camera 520 and on the direction of attention of the user detected by the face detection unit 210.

Accordingly, the laptop PC 1 switches between the internal camera 120 and the external camera 520 in accordance with the direction of attention of the user and thus, is capable of automatically switching to an appropriate camera among the plurality of cameras. The laptop PC 1 detects the direction of attention of the user using the internal camera 120 regardless of which of the internal camera 120 or the external camera 520 is selected, and thus, does not need to detect the direction of attention of the user in the external camera 520. Thus, special processing (for example, the camera switching control processing) does not need to be performed in the external camera 520, and a general-purpose camera is applicable as the external camera 520.

In the camera selection processing, the main processing unit 300 selects the camera at the position closer to the direction of attention of the user out of the internal camera 120 and the external camera 520.

Accordingly, the laptop PC 1 selects the camera at the position closer to the direction of attention of the user out of the internal camera 120 and the external camera 520 and thus, is capable of automatically switching to an appropriate camera among the plurality of cameras.

For example, the face detection unit 210 detects the direction of the face (for example, the face angle) of the user as the direction of attention of the user. In the camera selection processing, the main processing unit 300 selects the camera for capturing the image to be used for the processing of the application 350 from the internal camera 120 and the external camera 520, based on the positional relationship between the internal camera 120 and the external camera 520 and on the direction of the face (for example, the face angle) of the user detected by the face detection unit 210.

Accordingly, the laptop PC 1 switches between the internal camera 120 and the external camera 520 in accordance with the direction of the face (for example, the face angle) of the user and thus, is capable of automatically switching to an appropriate camera among the plurality of cameras.

The main processing unit 300 includes, as the options enabling the user to select the camera for capturing the image to be used for the processing of the application 350, the virtual camera 320 that is switched by selecting any of the internal camera 120 or the external camera 520 through the camera selection processing, in addition to the internal camera 120 and the external camera 520. In a case where the virtual camera 320 is selected by the user (for example, in a case where AUTO illustrated in FIG. 7 is selected), the main processing unit 300 executes the camera selection processing.

Accordingly, for example, the laptop PC 1 performs a control of automatically switching between the internal camera 120 and the external camera 520 by simply causing the user to select a specific option (for example, AUTO) on an existing camera selection UI, and thus, is capable of automatically switching to an appropriate camera among the plurality of cameras without performing a complicated operation or a special operation.

The laptop PC 1 (an example of the information processing apparatus) according to one or more embodiments includes the internal camera 120, the external connection terminal 130 (an example of the connection unit) for connecting to the external camera 520, the system memory 304 (an example of the memory), the main processing unit 300 (an example of the processor), and the face detection unit 210 (an example of the detection unit). For example, the system memory 304 temporarily stores the image data of the image captured by the internal camera 120 or the external camera 520. The main processing unit 300 performs processing using the image of the image data stored in the system memory 304 by executing the application 350 (an example of the application program). The face detection unit 210 detects the direction of attention of the imaged person based on the image captured by the internal camera 120. The main processing unit 300 displays “INTERNAL CAMERA” (an example of a first option) for selecting the internal camera 120, “EXTERNAL CAMERA A” (an example of a second option) for selecting the external camera 520, and “AUTO” (an example of a third option) for selecting any of the internal camera 120 or the external camera 520, on the display unit 110 (or the display unit 510 of the external display device 5) as the options enabling the user to select the camera for capturing the image used for the processing of the application 350 (refer to FIG. 7). In a case where the user selects “AUTO”, the main processing unit 300 performs the camera selection processing of selecting the camera for capturing the image to be used for the processing of the application 350 from the internal camera 120 and the external camera 520, based on the positional relationship between the internal camera 120 and the external camera 520 and on the direction of attention of the user detected by the face detection unit 210.

Accordingly, the laptop PC 1 performs the control of automatically switching between the internal camera 120 and the external camera 520 by simply causing the user to select a specific option (for example, AUTO) as in the operation in selecting the internal camera 120 or the external camera 520, and thus, is capable of automatically switching to an appropriate camera among the plurality of cameras without performing a complicated operation or a special operation. The laptop PC 1 detects the direction of attention of the user using the internal camera 120 regardless of which of the internal camera 120 or the external camera 520 is selected, and thus, does not need to detect the direction of attention of the user in the external camera 520. Thus, special processing (for example, the camera switching control processing) does not need to be performed in the external camera 520, and a general-purpose camera is applicable as the external camera 520.

The face detection unit 210 further detects the direction of attention of the imaged user based on the image captured by the external camera 520. The main processing unit 300 detects the positional relationship between the internal camera 120 and the external camera 520 based on the direction of attention of the user detected by the face detection unit 210 based on the image captured by the internal camera 120 and on the direction of attention of the user detected based on the image captured by the external camera 520.

Accordingly, the laptop PC 1 is capable of switching to an appropriate camera in accordance with the direction of attention of the user, by detecting the positional relationship between the internal camera 120 and the external camera 520.

For example, the main processing unit 300 detects the positional relationship between the internal camera 120 and the external camera 520 in response to connection of the external camera 520.

Accordingly, the laptop PC 1 is capable of detecting the positional relationship between the internal camera 120 and the external camera 520 at a timing when the external camera 520 is connected.

The main processing unit 300 may detect the positional relationship between the internal camera 120 and the external camera 520 at predetermined time intervals (for example, at 30-minute intervals) after the external camera 520 is connected.

Accordingly, even in a case where the positional relationship between the internal camera 120 and the external camera 520 changes after the external camera 520 is connected, the laptop PC 1 is capable of updating the positional relationship to the positional relationship after change and switching to an appropriate camera in accordance with the direction of attention of the user.

The main processing unit 300 may display a setting screen enabling the user to set the position of the external camera 520 with respect to a position of the internal camera 120, on the display unit 110. The main processing unit 300 may detect the positional relationship between the internal camera 120 and the external camera 520 based on the position of the external camera 520 with respect to the position of the internal camera 120, set by an operation of the user on the setting screen.

FIG. 9 is a diagram illustrating an example of a camera position setting screen according to one or more embodiments. A camera position setting screen G2 illustrated in the drawing is displayed as a UI allowing the user to set the position of the external camera 520 with respect to the position of the internal camera 120. A center of the camera position setting screen G2 corresponds to the position of the internal camera 120, and each position of left, right, up, and down with respect to the center is an option of the position of the external camera 520. The main processing unit 300 sets the position of the external camera 520 by causing the user to perform an operation of moving the cursor CA to any position of left, right, up, or down and determining (clicking) the position using the touchpad 153, the mouse, or the like. In the example illustrated in FIG. 9, “LEFT” is selected as the position of the external camera 520, which indicates an operation of setting the position of the external camera 520 to left in accordance with the use environment in FIG. 3.

Accordingly, the user is capable of setting the positional relationship between the internal camera 120 and the external camera 520 through a simple operation. Thus, the laptop PC 1 is capable of automatically switching to an appropriate camera among the plurality of cameras without performing complicated processing.

In the example illustrated in FIG. 9, a configuration of enabling the position for setting the position of the external camera 520 to be selected from the positions in four directions of left, right, up, and down with respect to the position of the internal camera 120 has been described. However, the present invention is not limited to the configuration. For example, the position of the external camera 520 may be configured to be selected from the positions in two directions of left and right or may be configured to be selected from the positions in two directions of up and down. The position of the external camera 520 may be configured to be selected from positions in more than four directions, including upper left, lower left, upper right, lower right, and the like in addition to the four directions of left, right, up, and down. In addition to the direction, a distance from the internal camera 120 (for example, selected from less than 30 cm, 30 cm or more and less than 50 cm, 50 cm or more and less than 1 m, and 1 m or more) may be configured to be selected.

The external camera 520 may be incorporated in the external display device 5 (an example of an external display device) including the external display unit 510 connected to the laptop PC 1. In this case, the main processing unit 300 may detect the positional relationship between the internal camera 120 and the external camera 520 based on setting information of a position of the external display unit 510 with respect to a position of the internal display unit 110 included in the laptop PC 1. For example, the main processing unit 300 refers to disposition information of displays in multi-display in a display setting of the operating system (OS) as the setting information of the position of the external display unit 510 with respect to the position of the internal display unit 110.

Accordingly, in a case where the external camera 520 is incorporated in the external display device 5, the laptop PC 1 detects the positional relationship between the internal camera 120 and the external camera 520 using the disposition information of the external display and thus, is capable of automatically switching to an appropriate camera among the plurality of cameras without causing the user to perform a complicated operation or a special operation.

In the laptop PC 1 including the internal camera 120, the external connection terminal 130 (an example of the connection unit) for connecting to the external camera 520, the system memory 304 (an example of the memory) that temporarily stores the image data of the image captured by the internal camera 120 or the external camera 520, the main processing unit 300 (an example of the processor) that performs processing using the image of the image data stored in the system memory 304 by executing the application 350 (an example of the application program), and the face detection unit 210 (an example of the detection unit) that detects the direction of attention of the imaged user (an example of the person) based on the image captured by the internal camera 120, a control method according to one or more embodiments includes a step of acquiring, via the main processing unit 300, the direction of attention of the user (an example of the person) detected by the face detection unit 210, and a step of selecting, via the main processing unit 300, the camera for capturing the image to be used for the processing of the application 350 from the internal camera 120 and the external camera 520, based on the positional relationship between the internal camera 120 and the external camera 520 and on the direction of attention of the user detected by the face detection unit 210.

Accordingly, in the control method in the laptop PC 1, the internal camera 120 and the external camera 520 are switched in accordance with the direction of attention of the user, and thus, automatic switching to an appropriate camera among the plurality of cameras is enabled. In the control method in the laptop PC 1, the direction of attention of the user is detected using the internal camera 120 regardless of which of the internal camera 120 or the external camera 520 is selected, and thus, the direction of attention of the user does not need to be detected in the external camera 520. Thus, special processing (for example, the camera switching control processing) does not need to be performed in the external camera 520, and a general-purpose camera is applicable as the external camera 520.

In the laptop PC 1 including the internal camera 120, the external connection terminal 130 (an example of the connection unit) for connecting to the external camera 520, the system memory 304 (an example of the memory) that temporarily stores the image data of the image captured by the internal camera 120 or the external camera 520, the main processing unit 300 (an example of the processor) that performs processing using the image of the image data stored in the system memory 304 by executing the application 350 (an example of the application program), and the face detection unit 210 (an example of the detection unit) that detects the direction of attention of the imaged user (an example of the person) based on the image captured by the internal camera 120, a control method according to one or more embodiments includes a step of displaying, via the main processing unit 300, “INTERNAL CAMERA” (an example of the first option) for selecting the internal camera 120, “EXTERNAL CAMERA A” (an example of the second option) for selecting the external camera 520, and “AUTO” (an example of the third option) for selecting any of the internal camera 120 or the external camera 520 on the display unit 110 (or the display unit 510 of the external display device 5) as the options enabling the user to select the camera for capturing the image to be used for the processing of the application 350 (refer to FIG. 7), and a step of selecting, via the main processing unit 300, in a case where the user selects “AUTO”, the camera for capturing the image to be used for the processing of the application 350 from the internal camera 120 and the external camera 520, based on the positional relationship between the internal camera 120 and the external camera 520 and on the direction of attention of the user detected by the face detection unit 210.

Accordingly, in the control method in the laptop PC 1, the control of automatically switching between the internal camera 120 and the external camera 520 is performed by simply causing the user to select a specific option (for example, AUTO) as in the operation in selecting the internal camera 120 or the external camera 520, and thus, automatic switching to an appropriate camera among the plurality of cameras is enabled without performing a complicated operation or a special operation. In the control method in the laptop PC 1, the direction of attention of the user is detected using the internal camera 120 regardless of which of the internal camera 120 or the external camera 520 is selected, and thus, the direction of attention of the user does not need to be detected in the external camera 520. Thus, special processing (for example, the camera switching control processing) does not need to be performed in the external camera 520, and a general-purpose camera is applicable as the external camera 520.

While embodiments of the invention have been described in detail with reference to the drawings, specific configurations are not limited to individual embodiments, and the invention also includes designs and the like within a scope not departing from the spirit of the invention. For example, each configuration described in the embodiments above is applicable in any combination with the others.

The face detection unit 210 may detect a direction of a sight-line of the user as the direction of attention of the user. In the camera selection processing, the main processing unit 300 may select the camera for capturing the image to be used for the processing of the application 350 from the internal camera 120 and the external camera 520, based on the positional relationship between the internal camera 120 and the external camera 520 and on the direction of the sight-line of the user detected by the face detection unit 210.

Accordingly, the laptop PC 1 switches between the internal camera 120 and the external camera 520 in accordance with the direction of the sight-line of the user and thus, is capable of automatically switching to an appropriate camera among the plurality of cameras.

The face detection unit 210 may detect the direction of the face (for example, the face angle) of the user and the direction of the sight-line of the user as the direction of attention of the user. In the camera selection processing, the main processing unit 300 may select the camera for capturing the image to be used for the processing of the application 350 from the internal camera 120 and the external camera 520, based on the positional relationship between the internal camera 120 and the external camera 520 and on the direction of the face (for example, the face angle) of the user and the direction of the sight-line of the user detected by the face detection unit 210.

Accordingly, the laptop PC 1 switches between the internal camera 120 and the external camera 520 in accordance with the direction of the face (for example, the face angle) of the user and with the direction of the sight-line of the user and thus, is capable of automatically switching to an appropriate camera among the plurality of cameras.

In the use environment (refer to FIG. 3) in which the user is attending the web conference or the like in front of two displays (the internal display and the external display), in a case where the user sees the other display for a short time (instantaneously) from the display to which the user is currently paying attention, the user generally changes only the sight-line to the other display. Meanwhile, in a case where the user sees the other display with attention, the user is considered to also change the direction of the face to the other display.

Thus, in switching between the internal camera 120 and the external camera 520 in accordance with the direction of the face (for example, the face angle) of the user, the laptop PC 1 is capable of suppressing unnecessary switching of the camera following a change in a case where the direction of attention of the user changes in a short time (instantaneously).

Meanwhile, for a purpose of quickly switching the camera following a change in a case where the direction of attention of the user changes in a short time (instantaneously), the laptop PC 1 is capable of implementing the purpose by switching between the internal camera 120 and the external camera 520 in accordance with the direction of the sight-line of the user.

In switching between the internal camera 120 and the external camera 520 in accordance with both of the direction of the face (for example, the face angle) of the user and the direction of the sight-line of the user, the laptop PC 1 is also capable of switching to an appropriate control between a control using the direction of the face (for example, the face angle) and a control using the direction of the sight-line, in accordance with a purpose, a condition, or the like.

While a configuration example of connecting one external camera 520 to the laptop PC 1 has been described in one or more embodiments, a plurality of external cameras 520 may be connected. For example, the laptop PC 1 may select, as the camera for capturing the image to be used in the processing of the application 350, a camera at a position closest in the direction of attention of the user among the internal camera 120 and the plurality of external cameras 520, based on a positional relationship among the internal camera 120 and the plurality of external cameras 520 and on the direction of attention of the user detected from the captured image captured by the internal camera 120.

While an example of switching between the internal camera 120 and the external camera 520 using the virtual camera 320 has been described in one or more embodiments, the virtual camera 320 may not be used. For example, a path for directly inputting the image data into the camera driver 340 from the internal camera 120 and a path for directly inputting the image data into the camera driver 340 from the external camera 520 may be configured to be switched without using the virtual camera 320.

The CPU 301 and the chipset 303 may be configured as individual processors or may be configured to be integrated as one processor.

While an example of providing the face detection unit 210 separately from the CPU 301 and the chipset 303 has been described in one or more embodiments, a part or the entirety of the face detection unit 210 may be included in the chipset 303 or may be included in a processor integrated with the CPU 301 or the chipset 303. For example, the CPU 301, the chipset 303, and the face detection unit 210 may be configured as individual processors or may be configured to be integrated as one processor. A part or the entirety of the face detection unit 210 may be included in the EC 200.

The waiting state may include a hibernation state, a power-off state, and the like. For example, the hibernation state corresponds to the state S4 defined in ACPI. For example, the power-off state corresponds to the state S5 (a shut-down state) defined in ACPI. The standby state, the sleep state, the hibernation state, the power-off state, and the like of the waiting state are states having a lower amount of power consumption than the normal operating state (states with suppressed power consumption).

The laptop PC 1 includes a computer system. A program for implementing the functions of each configuration included in the laptop PC 1 may be recorded on a computer-readable recording medium, and the program recorded on the recording medium may be read into the computer system and executed to perform the processing in each configuration included in the laptop PC 1. Here, the expression “the program recorded on the recording medium is read into the computer system and executed” includes installation of the program on the computer system. The term “computer system” includes the OS and hardware such as peripheral devices. The term “computer system” may include a plurality of computer apparatuses connected through a network including a communication line such as the Internet, a WAN, a LAN, or a dedicated line. The term “computer-readable recording medium” means a portable medium such as a flexible disk, a magneto-optical disc, a ROM, or a CD-ROM, or a storage device such as a hard disk incorporated in the computer system. Accordingly, the recording medium storing the program may be a non-transitory recording medium such as a CD-ROM.

The recording medium also includes an internally or externally provided recording medium that is accessible from a distribution server in order to distribute the program. The program may be configured to be divided into a plurality of programs and combined in each configuration included in the laptop PC 1 after being downloaded at different timings, or the distribution server for distributing each divided program may vary. The term “computer-readable recording medium” further includes a medium that holds the program for a certain time, such as a volatile memory (RAM) in the computer system as a server or a client in a case where the program is transmitted through the network. The program may be a program for implementing a part of the functions. The program may further be a so-called difference file (a difference program) capable of implementing the functions in combination with a program already recorded in the computer system.

A part or the entirety of each function included in the laptop PC 1 in one or more embodiments may be implemented as an integrated circuit based on large scale integration (LSI) or the like. Each function may be individually implemented as a processor, or a part or the entirety of the functions may be integrated into a processor. A circuit integration method is not limited to LSI and may be implemented by a dedicated circuit or a general-purpose processor. In a case where a circuit integration technique replacing LSI is available along with advances in semiconductor technique, an integrated circuit based on the technique may be used.

The laptop PC 1 of the embodiments above is not limited to a PC of a laptop type and may be, for example, a PC of a desktop type.

### DESCRIPTION OF SYMBOLS

1 laptop PC
10 first chassis
20 second chassis
15 hinge mechanism
110 display unit (internal display)
120 internal camera (imaging unit)
130 external connection terminal
140 power button
150 input device
151 keyboard
153 touchpad
160 communication unit
170 storage unit
180 audio system
181 microphone
182 speaker
200 EC
210 face detection unit
300 main processing unit
301 CPU
302 GPU
303 chipset
304 system memory
310 camera switching control unit
311 position detection unit
312 setting unit
313 switching setting table
314 camera switching unit
320 virtual camera
330 face information acquisition unit
340 camera driver
350 application
400 power supply unit
5 external display device
510 display unit (external display)
520 external camera

What is claimed is:

1. An information processing apparatus comprising:
an internal camera;
a connection unit configured to connect to one or a plurality of external cameras;
a memory configured to temporarily store image data of an image captured by the internal camera or the external camera;
a processor configured to perform processing using the image of the image data stored in the memory by executing an application program; and
a detection unit configured to detect a direction of attention of an imaged person based on the image captured by the internal camera,
wherein the processor is configured to perform camera selection processing of selecting a camera for capturing an image to be used for the processing from the internal camera and the external camera, based on a positional relationship between the internal camera and the external camera and on the direction of attention of the person detected by the detection unit.

2. The information processing apparatus according to claim 1,
wherein the detection unit is configured to detect a direction of a face of the person as the direction of attention of the person, and
the processor is configured to, in the camera selection processing, select the camera for capturing the image to be used for the processing from the internal camera and the external camera, based on the positional relationship between the internal camera and the external camera and on the direction of the face of the person detected by the detection unit.

3. The information processing apparatus according to claim 1,
wherein the detection unit is configured to detect a direction of a sight-line of the person as the direction of attention of the person, and
the processor is configured to, in the camera selection processing, select the camera for capturing the image to be used for the processing from the internal camera and the external camera, based on the positional relationship between the internal camera and the external camera and on the direction of the sight-line of the person detected by the detection unit.

4. The information processing apparatus according to claim 1,
wherein the detection unit is configured to detect a direction of a face of the person and a direction of a sight-line of the person as the direction of attention of the person, and
the processor is configured to, in the camera selection processing, select the camera for capturing the image to be used for the processing from the internal camera and the external camera, based on the positional relationship between the internal camera and the external camera and on the direction of the face of the person and the direction of the sight-line of the person detected by the detection unit.

5. The information processing apparatus according to claim 1,
wherein the processor is configured to, in the camera selection processing, select a camera at a position closer to the direction of attention of the person out of the internal camera and the external camera.

6. The information processing apparatus according to claim 1,
wherein the processor
includes, as an option enabling a user to select the camera for capturing the image to be used for the processing, a virtual camera that is switched between the internal camera and the external camera by selecting any of the internal camera or the external camera through the camera selection processing, in addition to the internal camera and the external camera; and
is configured to, in a case where the user selects the virtual camera, execute the camera selection processing.

7. An information processing apparatus comprising:
an internal camera;
a connection unit configured to connect to one or a plurality of external cameras;
a memory configured to temporarily store image data of an image captured by the internal camera or the external camera;
a processor configured to perform processing using the image of the image data stored in the memory by executing an application program; and
a detection unit configured to detect a direction of attention of an imaged person based on the image captured by the internal camera,
wherein the processor is configured to:
display a first option for selecting the internal camera, a second option for selecting the external camera, and a third option for selecting any of the internal camera the external camera, on a display unit as an option enabling a user to select a camera for capturing an image to be used for the processing; and
in a case where the user selects the third option, perform camera selection processing of selecting the camera for capturing the image to be used for the processing from the internal camera and the external camera, based on a positional relationship between the internal camera and the external camera and on the direction of attention of the person detected by the detection unit.

8. The information processing apparatus according to claim 7,
wherein the detection unit is configured to further detect the direction of attention of the imaged person based on the image captured by the external camera, and
the processor is configured to detect the positional relationship between the internal camera and the external camera based on the direction of attention of the person detected by the detection unit based on the image captured by the internal camera and on the direction of attention of the person detected based on the image captured by the external camera.

9. The information processing apparatus according to claim 8,
wherein the processor is configured to detect the positional relationship between the internal camera and the external camera in response to connection of the external camera.

10. The information processing apparatus according to claim 9,
wherein the processor is configured to detect the positional relationship between the internal camera and the external camera at predetermined time intervals after the external camera is connected.

11. The information processing apparatus according to claim 7,
wherein the external camera is incorporated in an external display device including an external display unit connected to the information processing apparatus, and
the processor is configured to detect the positional relationship between the internal camera and the external camera based on setting information of a position of the external display unit with respect to a position of an internal display unit included in the information processing apparatus.

12. The information processing apparatus according to claim 7,
wherein the processor is configured to:
display a setting screen enabling a user to set a position of the external camera with respect to a position of the internal camera, on a display unit, and
detect the positional relationship between the internal camera and the external camera based on the position of the external camera with respect to the position of the internal camera, set by an operation of the user on the setting screen.

13. A control method in an information processing apparatus including an internal camera, a connection unit configured to connect to one or a plurality of external cameras, a memory configured to temporarily store image data of an image captured by the internal camera or the external camera, a processor configured to perform processing using the image of the image data stored in the memory by executing an application program, and a detection unit configured to detect a direction of attention of an imaged person based on the image captured by the internal camera, the control method comprising:
a step of acquiring, via the processor, the direction of attention of the person detected by the detection unit; and
a step of selecting, via the processor, a camera for capturing an image to be used for the processing from the internal camera and the external camera, based on a positional relationship between the internal camera and the external camera and on the direction of attention of the person detected by the detection unit.

14. A control method in an information processing apparatus including an internal camera, a connection unit configured to connect to one or a plurality of external cameras, a memory configured to temporarily store image data of an image captured by the internal camera or the external camera, a processor configured to perform processing using the image of the image data stored in the memory by executing an application program, and a detection unit configured to detect a direction of attention of an imaged person based on the image captured by the internal camera, the control method comprising:
a step of displaying, via the processor, a first option for selecting the internal camera, a second option for selecting the external camera, and a third option for selecting any of the internal camera or the external camera, on a display unit as an option enabling a user to select a camera for capturing an image to be used for the processing; and
a step of selecting, via the processor, in a case where the user selects the third option, the camera for capturing the image to be used for the processing from the internal camera and the external camera, based on a positional relationship between the internal camera and the external camera and on the direction of attention of the person detected by the detection unit.
